(19) United States
(12) Patent Application Publication
(10) Pub. No.: US 2014/0054884 A1
(43) Pub. Date: Feb. 27, 2014

(54) CONNECTING PIPE STRUCTURE FOR SUCTION SET

(71) Applicant: Hsuan-Chiao HO, Tongluo Township (TW)

(72) Inventor: Hsuan-Chiao HO, Tongluo Township (TW)

(73) Assignee: PACIFIC HOSPITAL SUPPLY CO., LTD.

(21) Appl. No.: 13/594,366

(22) Filed: Aug. 24, 2012

(51) Int. Cl. F16L 43/00

(52) U.S. Cl. 285/179

(57) ABSTRACT

A connecting pipe structure for a suction set is provided for connecting the suction set and a washing liquid bottle, and the suction set includes a tubular body and a washing connector perpendicularly interconnected to the tubular body. The connecting pipe structure comprises a first socket, a second socket and an interconnect pipe, and the first socket is sheathed on the washing connector, and the second socket is installed perpendicularly to the first socket, and the second socket is coupled to the washing liquid bottle, and the interconnect pipe is interconnected to the first socket and the second socket, and the interconnect pipe has an external diameter smaller than the external diameter of the first socket and the external diameter of the second socket. With the curved interconnect pipe, the second socket can swing with respect to the first socket.

### FIELD OF THE INVENTION

The present invention relates to a connecting pipe structure, in particular to the connecting pipe structure applied in a right-angled connection between a suction set and a washing liquid bottle.

### BACKGROUND OF THE INVENTION

With reference to FIG. 1 for a suction set 10 which is a commonly used medical consuming material, and the suction set 10 is provided for connecting a patient's bronchus, and the suction set 10 is connected to a negative pressure, so that the negative pressure extracts waste liquids in the bronchus. Since the suction set 10 is used repeatedly and it is necessary to wash the suction set 10, therefore a washing connector 12 is installed on a sidewall of a tubular body 11 of the suction set 10 and connected to a washing liquid bottle through a pipeline. The washing liquid bottle contains a washing liquid, and the negative pressure sucks the washing liquid into the suction set 10 to clean the suction set 10 and discharge the washing liquid from the suction set 10 through a liquid discharge pipe 13. An L-shaped elbow 40 is interconnected between the suction set 10 and the washing liquid bottle, so that the washing liquid bottle can be perpendicularly erected and fixed, and medical professionals can hold the suction set 10 by one hand, while operating the device to drive the negative pressure by the other hand.

However, the prior art still has the following drawbacks. When the washing liquid bottle is shaken, the L-shaped elbow 40 is shaken as well. As a result, a gap may be formed between the L-shaped elbow 40 and the washing connector 12 to cause an air leakage, and thus the conventional suction set fails to extract the washing liquid.

### SUMMARY OF THE INVENTION

Therefore, it is a primary objective of the present invention to provide a connecting pipe structure for connecting a suction set and a washing liquid bottle, and the connecting pipe structure has a curved structure to prevent air leakage occurred between the connecting pipe structure and the suction set when the washing liquid bottle is shaken.

To achieve the foregoing objective, the present invention provides a connecting pipe structure for a suction set, and the connecting pipe structure is used for connecting a suction set and a washing liquid bottle, wherein the suction set comprises a tubular body and a washing connector perpendicularly interconnected to the tubular body, and the connecting pipe structure comprises a first socket, a second socket and an interconnect pipe. The first socket is sheathed on the washing connector, and the second socket is installed perpendicularly to the first socket, and the second socket is coupled to the washing liquid bottle, and the interconnect pipe is interconnected to the first socket and the second socket, The interconnect pipe has an external diameter smaller than the external diameter of the first socket and the external diameter of the second socket, so that the curved interconnect pipe can drive the second socket to swing with respect to the first socket.

Preferably, the interconnect pipe of the connecting pipe structure for a suction set is perpendicularly interconnected to a side of the first socket.

Preferably, the first socket of the connecting pipe structure for a suction set includes a first connecting end and a first open end extended from the first connecting end, and the second socket includes a second connecting end and a second open end extended from the second connecting end, wherein the first open end is sheathed on the washing connector, and the second open end is coupled to the washing liquid bottle, and the interconnect pipe is coupled to the first connecting end and the second connecting end.

Preferably, one end of the interconnect pipe of the connecting pipe structure for a suction set is interconnected to a side of the first connecting end.

Preferably, another end of the interconnect pipe of the connecting pipe structure for a suction set is interconnected to the second connecting end.

Preferably, a cleaning pipeline connector is installed at the washing liquid bottle of the connecting pipe structure for a suction set, and the second socket is sheathed on the cleaning pipeline connector to connect the washing liquid bottle.

Preferably, a cleaning pipeline connector is installed at washing liquid bottle of the connecting pipe structure for a suction set, and the second socket is sheathed on the cleaning pipeline connector to connect the washing liquid bottle.

Preferably, a cleaning pipeline connector is installed at the washing liquid bottle of the connecting pipe structure for a suction set, and the second open end is sheathed on the cleaning pipeline connector to connect the washing liquid bottle.

Preferably, a cleaning pipeline connector is installed at the washing liquid bottle of the connecting pipe structure for a suction set, and the second open end is sheathed on the cleaning pipeline connector to connect the washing liquid bottle.

In the connecting pipe structure of the present invention, the tubular body of the suction set and the washing liquid bottle can be installed substantially parallel to one another to facilitate a user to hold by one hand, so that the user can operate the negative pressure device by the other hand to overcome the drawbacks of the prior art.

### BRIEF DESCRIPTION OF THE DRAWINGS

FIG. 1 is a schematic view of a prior art;

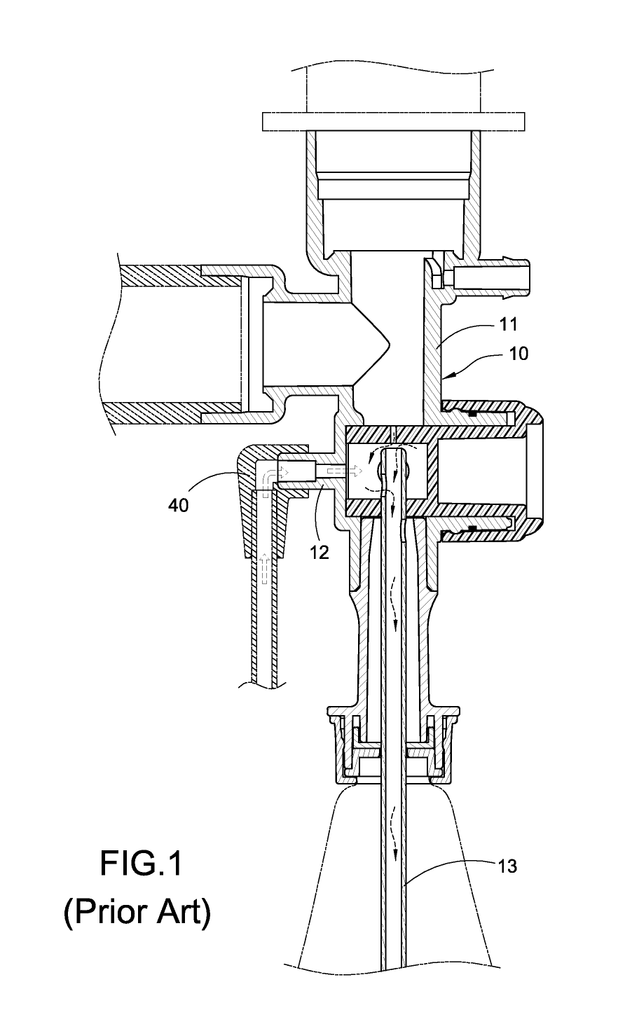

FIG. 2 is a schematic view of a connecting pipe structure in accordance with a first preferred embodiment of the present invention;

FIG. 3 is a cross-sectional view of a connecting pipe structure in accordance with the first preferred embodiment of the present invention;

FIG. 4 is a first schematic view showing an operating status of a connecting pipe structure in accordance with the first preferred embodiment of the present invention;

FIG. 5 is a second schematic view showing an operating status of a connecting pipe structure in accordance with the first preferred embodiment of the present invention; and

FIG. 6 is a schematic view showing another operating status of a connecting pipe structure in accordance with a second preferred embodiment of the present invention.

### DESCRIPTION OF THE PREFERRED EMBODIMENTS

The technical contents of the present invention will become apparent with the detailed description of preferred embodiments accompanied with the illustration of related drawings as follows.

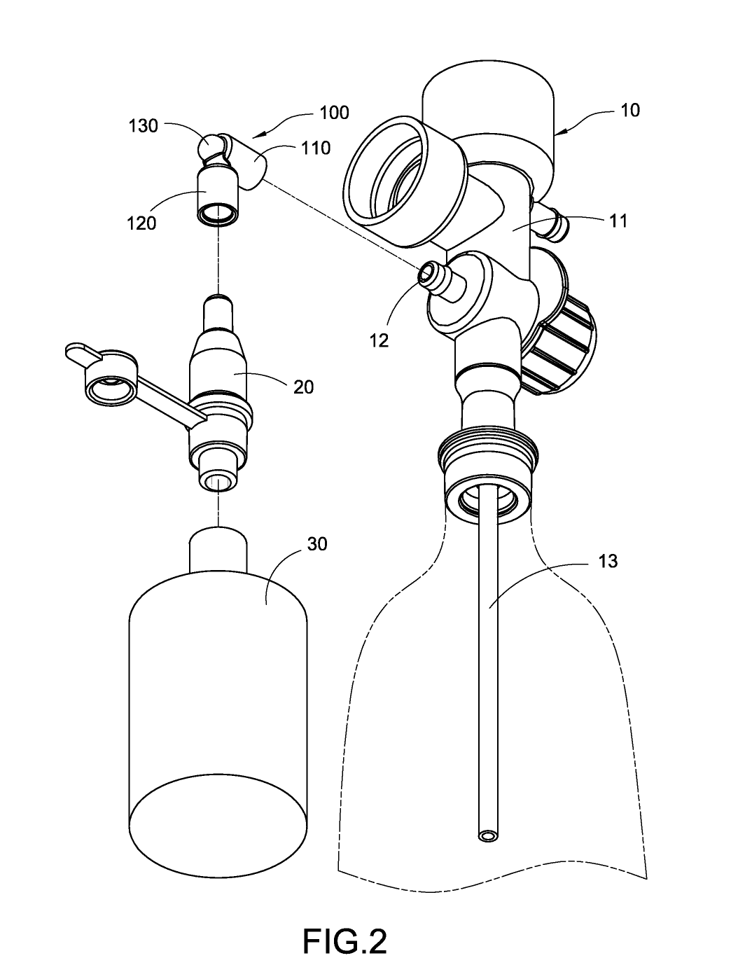

With reference to FIG. 2 for a connecting pipe structure 100 of the present invention, the connecting pipe structure 100 is used for connecting a suction set 10 and a washing liquid bottle 30, and the washing liquid bottle 30 contains a washing liquid and includes a cleaning pipeline connector 20 installed thereon, and the suction set 10 includes a tubular body 11, a washing connector 12 perpendicularly extended from a sidewall of the tubular body 11, and a liquid discharge pipe 13 coupled into the tubular body 11, wherein the liquid discharge pipe 13 is preferably coupled to a negative pressure. The connecting pipe structure 100 of the present invention is interconnected between the cleaning pipeline connector 20 and the washing connector 12, and a washing liquid is filled into the suction set 10 through the cleaning pipeline connector 20 and the connecting pipe structure 100 of the present invention for washing the suction set 10.

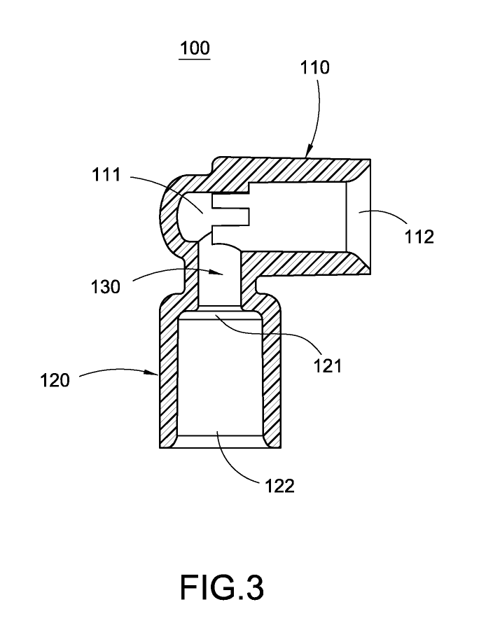

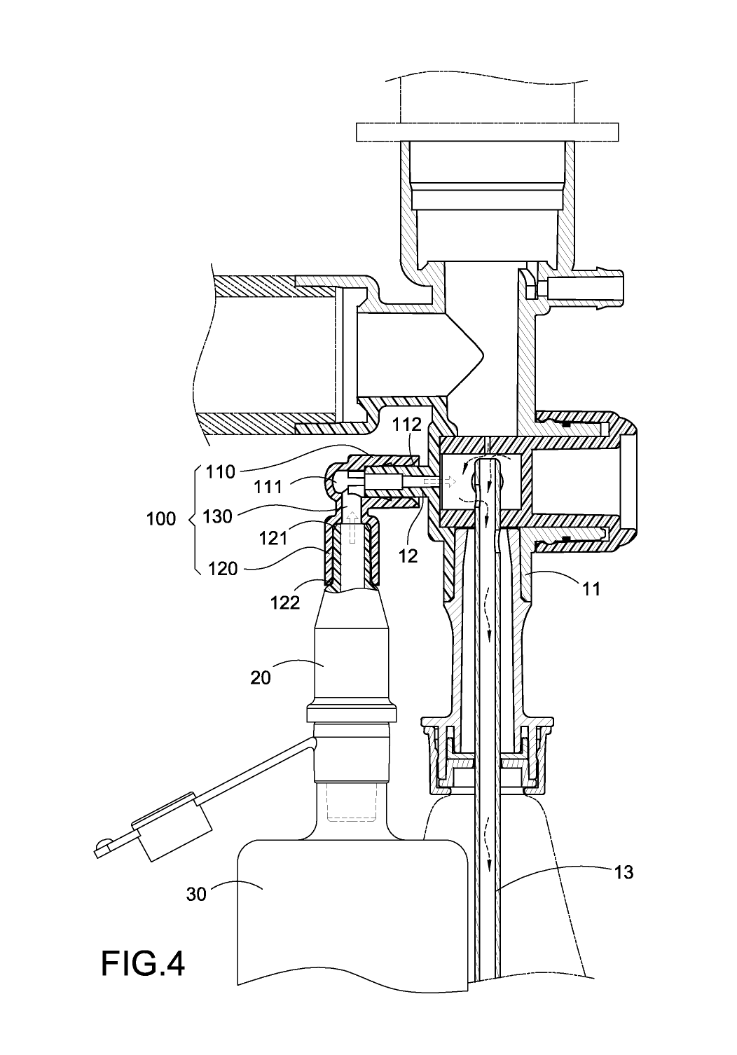

With reference to FIGS. 3 and 4, the connecting pipe structure 100 of the present invention comprises a first socket 110, a second socket 120 and an interconnect pipe 130, wherein the first socket 110, the second socket 120 and the interconnect pipe 130 are preferably integrally made of plastic. The first socket 110 is sheathed onto the washing connector 12, wherein the first socket 110 is a tubular body, and a first connecting end 111 and a first open end 112 extended from the first connecting end 111 are disposed at both ends of the tubular body respectively, and the first open end 112 is provided for being sheathed on the washing connector 12. The second socket 120 is provided for being coupled to the cleaning pipeline connector 20, wherein the second socket 120 is a tubular body, and a first socket 110 is perpendicularly installed, and a second connecting end 121 and a second open end 122 extended from the second connecting end 121 are disposed at both ends of the tubular body of the second socket 120 respectively, and the second open end 122 is coupled to the cleaning pipeline connector 20. In this preferred embodiment, the second open end 122 preferably has a pipe diameter greater than the pipe diameter of the cleaning pipeline connector 20, and the second open end 122 is sheathed on the cleaning pipeline connector 20. The interconnect pipe 130 is a tubular body and has a pipe diameter smaller than the pipe diameter of the first socket 110, and the pipe diameter of the second socket 120, and the interconnect pipe 130 is interconnected to the first socket 110 and the second socket 120. One of the ends of the interconnect pipe 130 is perpendicularly interconnected to a side of the first connecting end 111, and the other end is interconnected to the second connecting end 121.

With reference to FIG. 4, the suction set 10 is coupled to a negative pressure, and the washing liquid is driven by the negative pressure in the washing liquid bottle 30 to flow into the cleaning pipeline connector 20, the second socket 120, the interconnect pipe 130 and the first socket 110 of the connecting pipe structure 100 sequentially, and then flows into the suction set 10 through the washing connector 12 to rinse the suction set 10, and the rinsed washing liquid is driven by the negative pressure to pass through the liquid discharge pipe 13 and discharged from suction set 10.

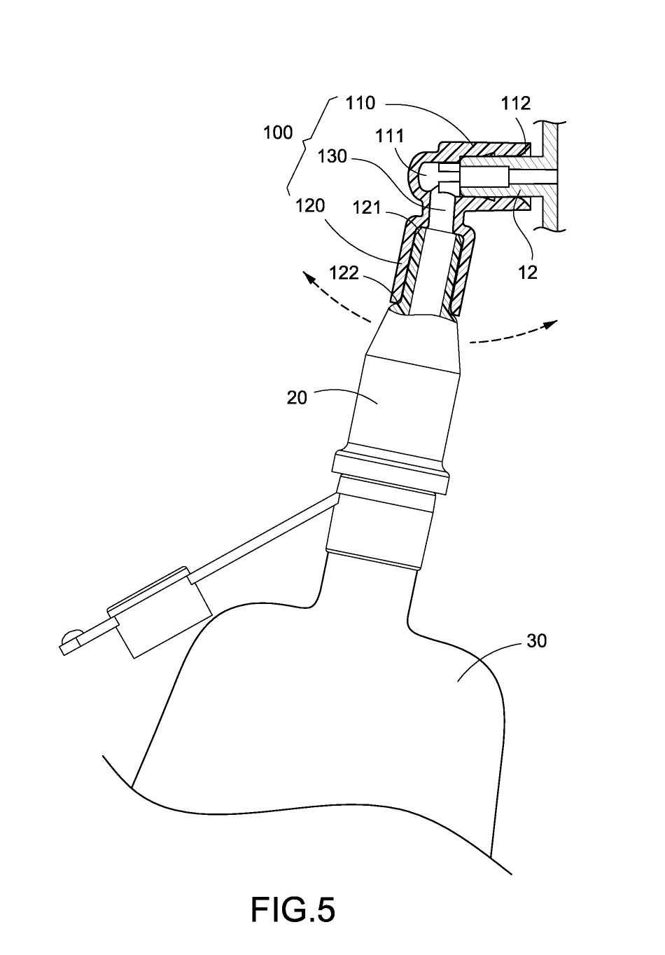

With reference to FIG. 5, the connecting pipe structure 100 of this preferred embodiment of the present invention is preferably made of a hard material, so that the connecting pipe structure 100 can erect the washing liquid bottle 30 perpendicularly, and the interconnect pipe 130 has an external diameter smaller than a curved neck composed of the first socket 110 and the second socket 120, and such structure can swing the second socket 120 with respect to the first socket 110, so that when the washing liquid bottle 30 is shaken, the curved interconnect pipe 130 acts as a buffer to maintain the first socket 110 still.

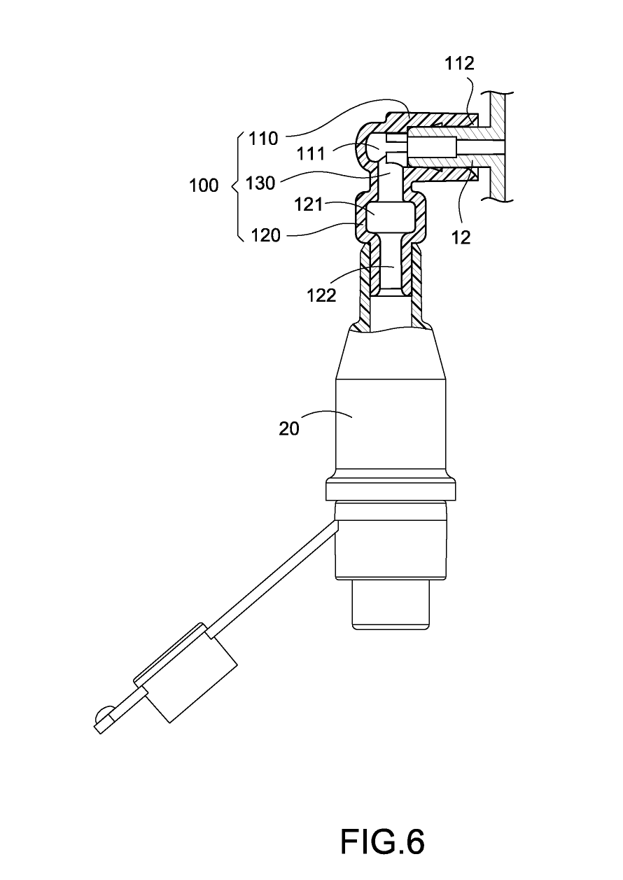

With reference to FIG. 6 for a connecting pipe structure 100 in accordance with a second preferred embodiment of the present invention, the connecting pipe structure 100 is provided for connecting a suction set 10 and a washing liquid bottle 30, and the washing liquid bottle 30 contains a washing liquid and includes a cleaning pipeline connector 20 installed thereon, and the connecting pipe structure 100 of the present invention fills the washing liquid into the suction set 10 through the cleaning pipeline connector 20 for cleaning the suction set 10.

The connecting pipe structure 100 of the present invention comprises a first socket 110, a second socket 120 and an interconnect pipe 130. In this preferred embodiment, the connecting pipe structure 100 is substantially the same as that of the first preferred embodiment, and the same parts will not be repeated. The difference between this preferred embodiment and the first preferred embodiment resides on that the connecting pipe structure 100 of this preferred embodiment has a second socket 120 which is a tubular body perpendicularly installed with respect to the first socket 110, and a second open end 122 and a second connecting end 121 are disposed at both ends of the second socket 120 respectively, and the second open end 122 has a pipe diameter preferably smaller than the pipe diameter of the cleaning pipeline connector 20, and the second open end 122 is coupled to the cleaning pipeline connector 20.

With the connecting pipe structure 100 of the present invention, the washing liquid bottle 30 can be erected perpendicularly. In addition, the curved interconnect pipe 130 allows the connecting pipe structure 100 of the present invention to be in a curved shape, so that when the washing liquid bottle 30 is shaken, the second socket 120 can swing with respect to the first socket 110 without driving the first socket 110 to shake or cause a leakage. In summation of the description above, the present invention overcomes the drawbacks of the prior art including the leakage occurred between the L-shaped elbow 40 and the washing connector 12 when the washing liquid bottle 30 is shaken.

While the invention has been described by means of specific embodiments, numerous modifications and variations could be made thereto by those skilled in the art without departing from the scope and spirit of the invention set forth in the claims.

What is claimed is:

1. A connecting pipe structure for a suction set, used for connecting the suction set and a washing liquid bottle, and the suction set comprising a tubular body and a washing connector interconnected to the tubular body, and the connecting pipe structure comprising:
a first socket, sheathed on the washing connector;
a second socket, installed perpendicularly to the first socket and coupled to the washing liquid bottle; and
an interconnect pipe, interconnected to the first socket and the second socket, and having an external diameter smaller than the external diameter of the first socket and the external diameter of the second socket, and the curved interconnect pipe allowing the second socket to swing with respect to the first socket.

2. The connecting pipe structure for a suction set according to claim 1, wherein the interconnect pipe is perpendicularly interconnected to a side of the first socket.

3. The connecting pipe structure for a suction set according to claim 1, wherein the first socket comprises a first connecting end and a first open end extended from the first connecting end, and the second socket comprises a second connecting end and a second open end extended from the second connecting end, and the first open end is sheathed on the washing connector, and the second open end is coupled to the washing liquid bottle, and the interconnect pipe is interconnected to the first connecting end and the second connecting end.

4. The connecting pipe structure for a suction set according to claim 3, wherein one end of the interconnect pipe is perpendicularly interconnected to a side of the first connecting end.

5. The connecting pipe structure for a suction set according to claim 4, wherein the other end of the interconnect pipe is interconnected to the second connecting end.

6. The connecting pipe structure for a suction set according to claim 1, wherein the washing liquid bottle includes a cleaning pipeline connector installed thereon, and the second socket is sheathed on the cleaning pipeline connector to connect the washing liquid bottle.

7. The connecting pipe structure for a suction set according to claim 1, wherein the washing liquid bottle includes a cleaning pipeline connector installed thereon, and the second socket is coupled to the cleaning pipeline connector to connect the washing liquid bottle.

8. The connecting pipe structure for a suction set according to claim 3, wherein the washing liquid bottle includes a cleaning pipeline connector, and the second open end is sheathed on the cleaning pipeline connector to connect the washing liquid bottle.

9. The connecting pipe structure for a suction set according to claim 3, wherein the washing liquid bottle includes a cleaning pipeline connector, and the second open end is coupled to the cleaning pipeline connector to connect the washing liquid bottle.
